(19) United States
(12) Patent Application Publication
(10) Pub. No.: US 2015/0126090 A1
(43) Pub. Date: May 7, 2015

(54) ENHANCED PERFORMANCE MATERIALS FOR TEXTILES AND METHODS OF MAKING THE SAME

(71) Applicant: TEX-TECH INDUSTRIES, INC., Portland, ME (US)

(72) Inventors: Thomas Nelson, Litchfield, ME (US); Eric Barter, Winthrop, ME (US); Robert Nelson, Waxhaw, NC (US)

(73) Assignee: TEX-TECH INDUSTRIES, INC., Portland, ME (US)

(21) Appl. No.: 14/070,022

(22) Filed: Nov. 1, 2013

(51) Int. Cl. D03D 11/00; D04H 1/46; B32B 5/26

(52) U.S. Cl. CPC D03D 11/00; B32B 5/26; D04H 1/46
USPC 442/318; 28/104; 28/158; 28/112

(57) ABSTRACT

The invention discloses high performance layered textile materials including at least one nonwoven layer sandwiched in between at least one first yarn based substrate layer and at least one second yarn based substrate layer. The non-woven layer has a first face and a second face, the first face being attached to and mechanically entangled with the first yarn based substrate layer and the second face being attached to and mechanically entangled with the second yarn based substrate layer. The formed integral material does not require assembly of individual layers prior to forming a finished product.

### STATEMENT REGARDING FEDERALLY SPONSORED RESEARCH OR DEVELOPMENT

Not applicable.

### BACKGROUND OF THE INVENTION

1. Field of the Invention

The invention relates to enhanced performance materials for textiles for textiles and methods for making the same. The materials have utility in the manufacture of products including for example garments for every day, sporting and other specialty uses.

2. Description of the Prior Art

The use of layered materials included padded and non-padded fabrics to enhance the performance of finished articles is known in the textile industry. Similarly, methods of making such layered materials is known. Typically, the patterns of each of the padded and non-padded fabrics are separately measured and cut out. The cut padded and non-padded patterns are then aligned and affixed to one another using, for example, an adhesive, in order to assemble the finished product.

Needle punching is an alternative method for affixing fabric layers to one another. Needle punching, sometimes referred to herein as needle felting or simply needling, is a process used in the textile industry in which an element such as a barbed needle is passed into and out of a fabric to entangle the fibers. Needle punching itself is not new, and is described in, for example, U.S. Pat. Nos. 5,989,375; 5,888,320; 5,323,523; 3,829,939; and 6,405,417, all of which are incorporated by reference.

The prior art has failed to teach needle felting of non-woven fabrics for use as, for example, padding, to woven or knit fabrics, however, because it has proven very difficult to pull the fibers of a non-woven fabric back up through a woven or knit fabric. Accordingly, industry has typically affixed foam for use as padding to a non-foam fabric using an adhesive to achieve a layered material.

There is a limitation in the performance of such layered materials due to an inherent instability in the resulting structure, however. Further, the necessity of separately measuring and cutting the padded and non-padded fabrics before the fabric patterns may be aligned and affixed to one another is labor intensive. Thus, there is a need for layered materials with high performance characteristics which can be conveniently manufactured.

### BRIEF SUMMARY OF THE INVENTION

In one aspect, the invention provides a material including at least a first and a second yarn based substrate layer and at least one non-woven layer having a first face and a second face, the first face being attached to and mechanically entangled with the first yarn based substrate layer and the second face being attached to and mechanically entangled with the second yarn based substrate layer, to form an integral material. In an embodiment of this aspect of the invention, the yarn based substrate layer includes a knit fabric. In another embodiment of this aspect, the yarn based substrate layer includes a woven fabric. In yet another embodiment of this aspect, the yarn based substrate layer includes a hybrid technology including a knit element and a woven element. A further embodiment of this aspect provides the nonwoven layer mechanically entangled with the yarn based substrate layers by needle punching. In yet a further embodiment, the integral material of the invention includes a water repellant coating. Another embodiment of this aspect provides the non-woven layer including at least a first specialty fiber having a first shrinkage rate and at least a second specialty fiber having a second shrinkage rate different and distinct from the first shrinkage rate.

In another aspect, the invention provides a method of making a material. The method includes inserting at least one non-woven layer having a first face and a second face in between at least a first yarn based substrate layer and at least a second yarn based substrate layer, and mechanically entangling fibers of the non-woven layer with fibers of the first face of the first yarn based substrate layer and fibers of the second face of the second yarn based substrate layer to form an integral material. In an embodiment of this aspect, at least one of the first and the second yarn based substrate layers includes a knit fabric. In another embodiment of this aspect, at least one of the first and the second yarn based substrate layers includes a woven fabric. In yet another embodiment of this aspect, at least one of the first and the second yarn based substrate layers includes a hybrid technology including a knit element and a woven element. In an additional embodiment of this aspect, the mechanically entangling step further includes needle punching. A further embodiment of this aspect includes applying a water repellant coating to an outside face of the integral material. In yet a further embodiment of this aspect, the non-woven layer includes at least a first specialty fiber having a first shrinkage rate and a second specialty fiber having a second shrinkage rate different and distinct from the first shrinkage rate.

### BRIEF DESCRIPTION OF THE SEVERAL VIEWS OF THE DRAWINGS

FIG. 1 is an exploded view of a material of the invention showing a non-woven layer interposed between two yarn based substrate layers.

FIG. 2 is a drawing showing an embodiment of the invention in the form of a brassiere design.

### DETAILED DESCRIPTION OF THE INVENTION

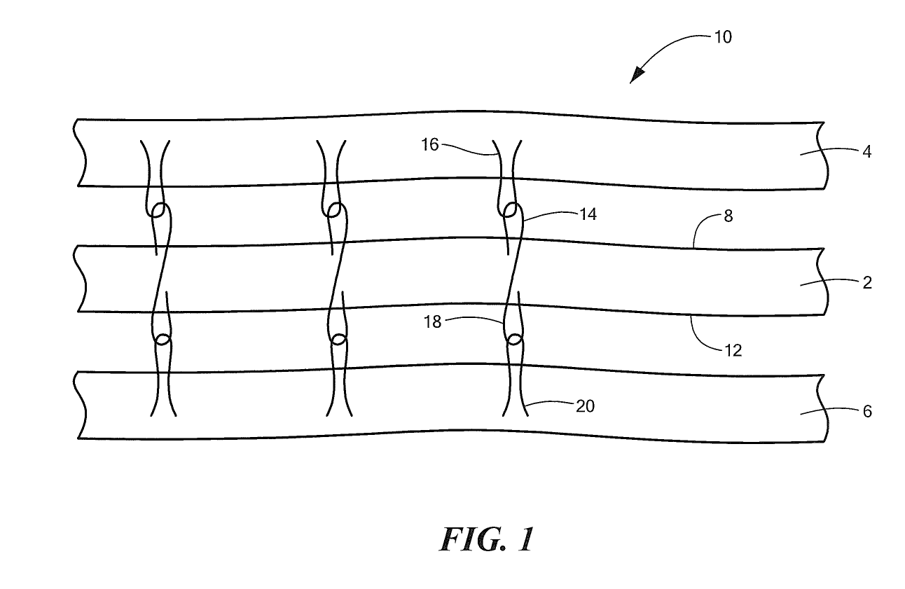

The present invention provides an enhanced performance, monolithic, integral structure with non-woven and yarn based substrate attributes. Referring to the drawings, the enhanced performance integral material 10 of the present invention is shown in a profile view in FIG. 1. At least one non-woven layer 2 is sandwiched between at least one first yarn based substrate layer 4 and at least one second yarn based substrate layer 6. The sandwiching of a non-woven layer 2 in between the yarn based substrate layers 4,6 provides dimensional stability to the structure. The yarn based substrate layers 4,6 protect the encapsulated non-woven layer 2 from abrasion and provide increased washability resistance. Although non-woven layer 2 is shown as a single layer, the non-woven layer 2 may consist of multiple layers. Such layers may be stacked one upon another. Similarly, although the yarn based substrate layers 4 and 6 are illustrated as single layers, each of these layers may include multiple layers and such multiple layers may be stacked.

The non-woven layer 2 is sandwiched between the two yarn based substrate layers 4 and 6 such that a first face 8 of the non-woven layer 2 abuts the first yarn based substrate layer 4 and a second face 12 of the non-woven layer 2 abuts the second yarn based substrate layer 6. The non-woven 2 and yarn based substrate 4, 6 layers are aligned together. In contrast to conventional materials, in the present invention, yarns 14 at the first face 8 of the non-woven layer 2 are mechanically entangled with the yarns 16 of the first yarn based substrate layer 4 and yarns 18 at the second face 12 of the non-woven layer 2 are mechanically entangled with yarns 20 of the second yarn based substrate layer 6 such that an integral material is formed.

The non-woven layer includes individual fibers which are bonded together. The bonding of the individual fibers in the non-woven layer is accomplished by methods known to those of ordinary skill in the art, such as, for example, mechanical entanglement such as, for example, needle punching, hydroentangling, and pressed felting or wet processing, electrospinning, melt blowing, thermal point bonding, chemical or resin bonding, and/or combinations thereof, etc. The non-woven layer provides dimensional stability and support to the surrounding yarn based substrate layers such that the surrounding yarn based substrate layers are less likely to distort, pull apart or unravel. The material of the non-woven layer functions somewhat like a foam. Accordingly, the material of the non-woven layer is selected to provide a rebound or recovery or resiliency quality to the formed integral material such that the non-woven layer acts like a trampoline upon pressure or the impact of an exterior object. The terms fabric resilience or resiliency are used interchangeably with the terms rebound or recovery quality for the purposes of this application. These terms refer to the ability of a fabric to spring back to its original shape after being twisted, crushed, wrinkled, or distorted in any way. “FabricLink|Textile Dictionary.” FabricLink|Textile Dictionary. N.p., n.d. Web. 5 Sep. 2013. The rebound or recovery quality of the non-woven layer is achieved through the selection of specialty fibers which have spring like qualities. Upon impact resulting in compression of fibers, the fibers spring or rebound much like a trampoline. The yarn based substrate layers of the invention include at least some stretch. Thus, when the integral material of the invention experiences compression or an impact, the affected yarn based substrate layer stretches to absorb the impact but is driven to return at least partially to its original shape by the spring back action of the non-woven layer.

The selection of materials for use as the non-woven and yarn based substrate layers of the integral material of the invention is based on fabric resilience, as defined above, and stretch and cover factor in light of the end use or application of the integral material. The fabric resilience is measured by standard measurement techniques known to those of ordinary skill in the art, such as, for example, ASTM D-2632. The stretch is also measured by standard measurement techniques known to those of ordinary skill in the art, such as, for example, ASTM-6614-07. Cover factor is defined as “the extent to which the area of a fabric is covered by one set of threads”. Handbook of Technical Textiles. Google Books. N.p., n.d. Web. 5 Sep. 2013. The cover factor is judged by subjective evaluation or by using a mathematical formula depending upon the fabric under consideration, as described further below. Laminar peel is measured by standard measurement techniques know to those of ordinary skill in the art, such as, for example, ASTM D5379. Elongation and strain are also measured by standard measurement techniques known to those of ordinary skill in the art, such as, for example, ASTM D5035. The ranges or degree of fabric resilience, stretch, cover, laminar peel, elongation and strain will depend upon the types of yarns or fibers selected for a particular application and the number of yarn substrate layers.

In one embodiment, at least one yarn based substrate layer includes a knit fabric. Knit fabrics include an inherent stretch because of the physical construction of a knit including series of loops which can stretch and compress. Accordingly, knit fabrics are preferable for use in the yarn-based substrate layer of the invention when a stretch factor of greater than 5% is required for a particular end use or application. Preferably, the knit fabrics used in the present invention exhibit a high cover factor approaching 100%. The evaluation of cover factor for knit fabrics is based on a subjective determination where a high cover factor approaching 100% is similar to the cover factor of a traditional T shirt. The knit fabrics for use in the present invention can also be selected based on comfort for the wearer and can include different textures know to those of ordinary skill in the art such as, for example, soft, silky or satiny textures.

In another embodiment, at least one yarn based substrate layer includes a woven fabric. Woven fabrics typically exhibit less stretch than the knit fabrics but have a relatively higher cover factor. A higher cover factor provides greater inner strength, dimensional stability and durability. The cover factor for woven fabrics is determined as follows:

Cover Factor for Woven Fabrics=(end yarns/cm)/10*sqrt(tex)+(warp yarns/cm)/10*sqrt(tex)

Preferably the woven fabrics for use in the present invention have a cover factor approaching or even exceeding 100% under certain weaving circumstances.

In yet another embodiment, at least one yarn based substrate layer includes a hybrid technology including knit and woven elements. In one embodiment, the hybrid technology is a hybrid weft technology. The hybrid weft technology can provide relatively high stretch in one direction but not necessarily high stretch in the other direction.

In a further embodiment, at least one yarn based substrate layer consists of knit or woven fabric, including unidirectional knit or woven fabric. In unidirectional knit or woven fabric, the yarns or fibers all run in the same direction. In embodiments where there are yarn substrate layers consisting of multiple layers of unidirectional knit or woven fabric, the yarns or fibers are preferably cross-laid at 90 degrees angle with respect to one another and held in place by lightly stitching, sewing or interweaving lightweight yarns such that the material remains manageable during the manufacturing processes without separating and without bending individual yarns.

In a further embodiment, at least one yarn based substrate layer consists of knit or woven fabrics including quasi-directional knit or woven fabrics. In quasi-directional knit or woven fabrics, the yarns or fibers may be laid in more than one direction.

In other embodiments, the knit and woven fabrics of the yarn based substrate layers can be knit or woven in a variety of styles including warp knit, weft knit, weft-insertion knit, circular knit, plain, basket, twill, stain and other complex knits and weaves including, but not limited to, alone or in combination, unidirectional, quasi uni-directional, and three-dimensional knit and woven fabrics.

The non-woven layer may be selected from natural fibers and synthetic fibers according to the desired application for the integral material. Natural fibers for use in the present invention include cotton, wool, sisal, linen, jute and silk. Synthetic fibers for use in the invention include aramid fibers, extended chain polyethylene fibers, PBO fibers based on Poly (p-phenylene-2,6-benzobisoxazole)polymers and developed by TOYOBA, regenerated cellulose, rayon, polynosic rayon, cellulose esters, acrylics, modacrylics, polyamides, polyolefins, polyester, rubber, synthetic rubber, saran, glass, polyacrylonitrile, acrylonitrile-vinyl chloride copolymers, polyhexamethylene adipamide, polycaproamide, polyundecanoamide, polyethylene, polypropylene and polyethylene terephthalate. Specialty bi-component polyester fibers with differing shrinkage rates are preferred as the non-woven layer in the present invention. Examples of such specialty bi-component polyester fibers include E-plex and Iscra fibers.

The yarns of the yarn based substrate layers may be selected from the same list of natural and synthetic fibers listed above for the non-woven layer, except that such materials would be provided in yarn rather than fiber form and would include, for example, staple, multifilament or monofilament yarns.

The weight and thickness of the integral material of the invention vary depending on the type and number of nonwoven and yarn based substrate layers selected, the amount of nonwoven fibers and yarns used in the respective nonwoven and yarn based substrate layers, the degree of mechanical entanglement discussed below, and the desired end use of the integral materials. Weights of the integral material can vary from 3 ounces per square yard to over 100 ounces per square yard. Thicknesses can vary from 0.010 inch to well over 1 inch depending upon the desired end use or application and the desired number of yarn based substrate layers and/or non-woven layers.

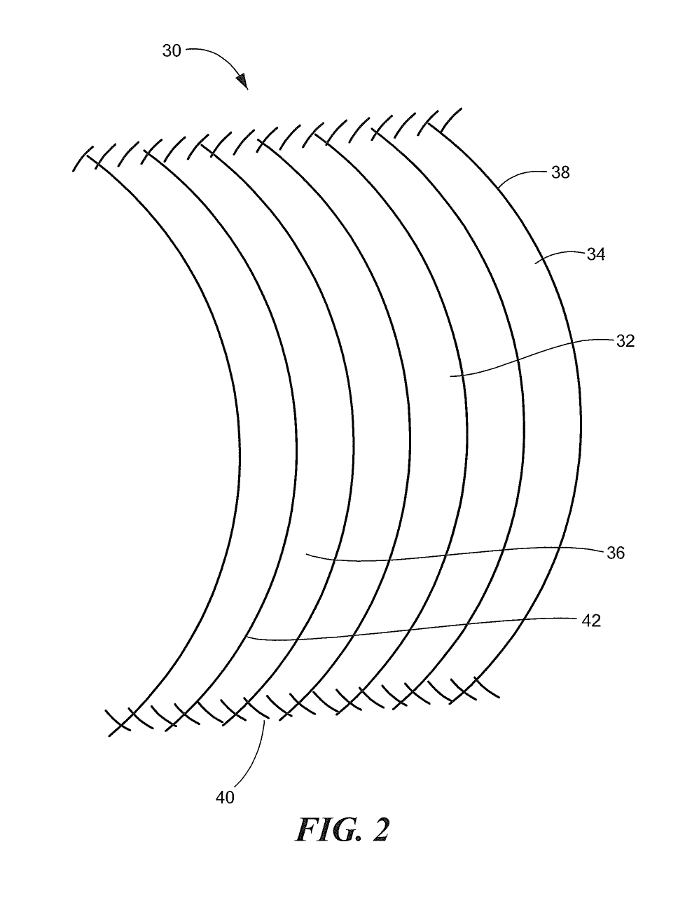

For example, in one embodiment, the material of the present invention is used in a cup for a brassiere 30 as shown in FIG. 2 or other type of intimate apparel. It is desired that the outside surface 38 of the first yarn based substrate layer 34 remain smooth regardless of the pressure exerted by the wearer's nipple on the inside surface 42 of the second yarn based substrate layer 36. It is also desired that the integral material 40 and in particular, the inside surface 42 of the second yarn based substrate layer 36 feel comfortable to the wearer. The entire integral material 40 of the brassiere should permit ease of movement without a huge amount of bulk. It is further desired that the brassiere 30 has a light material weight. Accordingly, in such an embodiment, the integral material is designed with a fabric resilience of at least 35% or higher to maintain an outer smooth surface regardless of variable compression caused to the inner surface of the integral material. Further, the integral material preferably includes a knit yarn based layer having a stretch factor greater than at least 5% to provide comfort and flexibility. In addition, the integral material is designed with a relatively small number of layers in each of the yarn based substrate layers 34 and 36 as well as the non-woven layer 32 again to promote flexibility.

In another embodiment, the integral material of the invention can be used as an absorbing impact material for withstanding impact from outside of the wearer. Such impact may result from, for example, collision with another athlete, a piece of sporting equipment such as a ball, or another type of projectile. Given maintenance of a smooth outer surface is not required in this embodiment, the integral material for use as an absorbing impact material preferably includes a fabric resilience of less than 10%. The integral material used as an absorbing impact material preferably includes a high cover factor with relatively high inner strength, dimensional stability and durability. It is desired that the finished article maintains flexibility and comfort for the wearer and has a light material weight, while more padding is desired to protect the wearer from the force of impact. In such an embodiment, therefore, more layers are used in either the yarn based substrate layers and/or the non-woven layer.

The mechanical entanglement of the nonwoven layer and the first and second yarn based substrate layers must be varied according to the fabric selected for the first and second yarn based substrate layers. Different methods of mechanical entanglement known to those of ordinary skill in the art such as, for example, hydroentanglement, the use of water or air jets, needle punching, and the like can be used in the present invention.

In a preferred embodiment, the mechanical entanglement is provided through needle punching which is also referred to as needle felting or needling, as discussed above. The term needle punching used herein encompasses all these terms. The variation of the needle punching process can include the amount of needle punches per unit area, the depth of those punches and/or the types of needles used. These settings are varied according based on the desired end use or application of the integral material. The process of mechanical entanglement increases interlaminar sheer strength and flexibility of the material over conventional materials which rely on adhesives for attaching various fabric layers.

Once the nonwoven layer is mechanically entangled and thus firmly attached to the yarn based substrate layers, the formed integral material is ready for use in the manufacture of finished articles without requiring assembly of individual layers. For example, if the integral material is used by a clothing manufacturer to create a particular garment, the manufacturer can cut a unit of the formed integral material of the present invention from a single roll of fabric that has been tested to meet specific requirements. This method avoids the additional labor of cutting many layers of fabric, stacking, counting and quilting or sticking layers together. The integral material is thus “ready-made” offering economic as well as performance advantages in a single integral material that then can be used as a building block to create various constructions in numerous potential productions.

After mechanical entanglement, optionally, the formed integral material can be further consolidated by calendaring the needled material through nip rolls. Calendering in a nip roll further densifies the material and reduces the overall thickness profile of the material. Calendering is the process of applying pressure, and sometimes heat, to a material for further densification.

Due to the increased performance of the formed integral materials of the invention, less material can be used to achieve to achieve equivalent performance making the end products lighter weight, more flexible, and more durable compared to conventional processing.

Conventional secondary steps can be used to enhance the integral materials of the present invention. For example, coatings known in the art, such as, for example, a water repellant polytetrafluoroethylene coating can be advantageously applied to the formed integral material to improve performance.

The following example demonstrates fabrics prepared according to the invention.

### Example 1

A nonwoven material (which may be manufactured, for example, by dry laid carding and mechanical needling) including 50% E-Plex and 50% 2 denier Polyester fibers and having an areal weight of about 2.5 oz./sq.yd. (84.78 g/m²) and a thickness of about 0.060 in. (0.152 cm) was placed at the inlet side of a needlepunch loom on an automatic roll feed system timed to feed the material at the same rate as the machine speed. Layers of quasi-unidirectional yarn based knit substrate materials including 100% Polyester fibers were arranged such that the nonwoven material was situated between layers of the knit materials on the inlet side of the needlepunch loom. The leading edge of the knit layers were then tacked together to a leader fabric (a fabric used solely to bring another material through the needlepunch loom) for stability. The nonwoven fabric was fed to the needlepunch loom edge and the entire system of nonwoven and knit materials was fed into the needlepunch loom for consolidation. The step of interposing a nonwoven layer between the knit layers included placing a nonwoven layer between the knit layers on the loom.

The first pass through the needlepunch loom entangled the nonwoven layer through the first layer of knit fabric, and used 400 penetration/sq.in. (62 penetrations/cm²) with an 8 mm penetration of needle into the materials. A finishing needle was used. The machine ran at 1.6 yards/minute (1.46 m/min.). The material was then flipped over on top of the second knit layer. The integral material was then run through the loom a second time. The second pass was to ensure that all of the knit layers were mechanically entangled in the z-direction with the nonwoven layer. The second pass through the loom was at 600 penetrations/sq. inch (93 penetrations/cm²) with an 8 mm penetration of needle into the materials. For this pass, the machine ran at 2.0 yards/minute (1.83 m/min.).

The nonwoven layer was firmly interposed between the knit layers and the finished material was ready for use as a monolithic integral material without requiring assembly of individual layers. Samples of the finished integral material were cut in the machine direction across the width of the finished integral material for testing because samples cut this direction tends to be weaker than the samples cut in the cross direction. Resiliency, laminar peel, elongation and strength of the samples were then measured as described below at a room temperature of 70° F. and the results are provided in Table I.

Resiliency of the resulting integral material was measured using ASTM D2632. A steel ball was dropped from a height onto the material, and a percentage was calculated based upon the rebound of the ball.

Laminar peel of the resulting integral material was measured using ASTM D 5379. Each of the knit layers was grabbed and peeled away from the non-woven layer.

Elongation and strain were measured according to ASTM D5035. The % strain refers to the maximum force assumed by the fabric prior to a breakage.

TABLE I
Integral Material Samples with
Needlepunching

| | Test | | |
|---|---|---|---|
| | 1 | 2 | 3 |
| Resiliency | 12% | 11% | 12% |
| Laminar | .51 lbf | .69 lbf | .66 lbf |
| Peel | | | |
| Elongation | 186.47 lbf | 187.36 lbf | 188.24 lbf |
| Strain | 84.88% | 85.88% | 86.88% |

### Example 2

An adhesively adhered material was then prepared by interposing the same type of non-woven layer in between two yarn based knit substrate layers as described above in Example 1 and affixing by hand the layers to one another using a 3M General Purpose 45 spray adhesive. Samples of the finished adhesively adhered material were cut in the machine direction across the width of the finished integral material again because such samples tend to be weaker than those samples cut in the cross direction. Resiliency, laminar peel, elongation and strength of the samples was measured using the same methods as described in Example 1, at a room temperature of 60° F., and the test results are provided in Table II. Naturally, the results of such testing can vary across orders of magnitude based on the adhesive used. Notably, the hand application of the spray adhesive resulted in difficulties in controlling the exact amount of adhesive over a particular area and contributed to variability in the test results particularly with respect to the strain values. Furthermore, the use of adhesive resulted in a stiffer feeling material in comparison of the needlepunched integral material of Example 1.

TABLE II
Adhesively Adhered Samples

| | Test | | |
|---|---|---|---|
| | 1 | 2 | 3 |
| Resiliency | 10% | 10.3% | 8.1% |
| Laminar | .47 lbf | .52 lbf | .44 lbf |
| Peel | | | |
| Elongation | 185.31 lbf | 186.78 lbf | 185.82 lbf |
| Strain | 87.43% | 83.92% | 82.10% |

The foregoing examples and detailed description are not to be deemed limiting of the invention which is defined by the following claims. The invention is understood to encompass such obvious modifications thereof as would be apparent to those of ordinary skill in the art.

What is claimed is:

1. A material comprising at least a first and a second yarn based substrate layer and at least one non-woven layer having a first face and a second face, the first face being attached to and mechanically entangled with the first yarn based substrate layer and the second face being attached to and mechanically entangled with the second yarn based substrate layer, to form an integral material.

2. The material of claim 1, wherein the yarn based substrate layer comprises a knit fabric.

3. The material of claim 1, wherein the yarn based substrate layer comprises a woven fabric.

4. The material of claim 1, wherein the yarn based substrate layer comprises a hybrid technology including a knit element and a woven element.

5. The material of claim 1, wherein the nonwoven layer is mechanically entangled with the yarn based substrate layers by needle punching.

6. The material of claim 1, further comprising a water repellant coating.

7. The material of claim 1, wherein the non-woven layer comprises at least a first specialty fiber having a first shrinkage rate and at least a second specialty fiber having a second shrinkage rate different and distinct from the first shrinkage rate.

8. A method of making a material comprising the steps of:
inserting at least one non-woven layer having a first face and a second face in between at least a first yarn based substrate layer and at least a second yarn based substrate layer, and
mechanically entangling a plurality of fibers of the non-woven layer with a plurality of fibers of the first face of the first yarn based substrate layer and a plurality of fibers of the second face of the second yarn based substrate layer to form an integral material.

9. The method of claim 8, wherein at least one of the first and the second yarn based substrate layers comprises a knit fabric.

10. The method of claim 8, wherein at least one of the first and the second yarn based substrate layers comprises a woven fabric.

11. The method of claim 8, wherein at least one of the first and the second yarn based substrate layers comprises a hybrid technology including a knit element and a woven element.

12. The method of claim 8, wherein the mechanically entangling step further comprises needle punching.

13. The method of claim 8, further comprising the step of
applying a water repellant coating to an outside face of the integral material.

14. The method of claim 8, wherein the non-woven layer comprises at least a first specialty fiber having a first shrinkage rate and a second specialty fiber having a second shrinkage rate different and distinct from the first shrinkage rate.
